(19) United States
(12) Patent Application Publication
(10) Pub. No.: US 2018/0365652 A1
(43) Pub. Date: Dec. 20, 2018

(54) PROVIDING ANOMALY BASED NOTIFICATION ON CALENDAR

(71) Applicant: MICROSOFT TECHNOLOGY LICENSING, LLC, Redmond, WA (US)

(72) Inventors: Shahil SONI, Seattle, WA (US); Manjot Singh PAL, Seattle, WA (US)

(73) Assignee: MICROSOFT TECHNOLOGY LICENSING, LLC, Redmond, WA (US)

(21) Appl. No.: 15/624,031

(22) Filed: Jun. 15, 2017

(51) Int. Cl. G06Q 10/10

(52) U.S. Cl. CPC G06Q 10/1095

(57) ABSTRACT

Variety of approaches to provide an anomaly based notification on a calendar are described. A hosted service initiates operation (s) to provide the anomaly based notification upon detecting an anomaly associated with a calendar event. Next a change operation associated with the anomaly is determined based on a context of the calendar event and a type of the anomaly. A notification is provided for a presentation on the calendar that renders the calendar event. The notification includes an interactive element associated with the change operation.

### BACKGROUND

Information exchange have changed processes associated work and personal environments. Automation and improvements in processes have expanded scope of capabilities offered for personal and business data consumption. With the development of faster and smaller electronics, execution of mass processes at cloud systems have become feasible. Indeed, applications provided by data centers, data warehouses, data workstations have become common features in modern personal and work environments. Scheduling service(s) provide a wide variety of applications ranging from hosting, management, facilitating event organization, among others associated with calendar based event(s).

Increasingly, cloud based resources are utilized for variety of services that include scheduling services, among others that facilitate hosting, management, and/or collaboration, among other operations associated with assets such as calendar events(s). However, there are currently substantial gaps in dynamically mitigating anomaly(s) associated with calendar event(s). Personnel resources are unnecessarily consumed for analyzing, detecting, and/or processing anomaly(s) in calendar event(s). Lack of relevant management solutions to dynamically provide anomaly mitigation in calendar event(s) cause poor management of personnel resources and time when attempting to recognize and/or mitigate anomaly(s) in calendar event(s).

### SUMMARY

This summary is provided to introduce a selection of concepts in a simplified form that are further described below in the Detailed Description. This summary is not intended to exclusively identity key features or essential features of the claimed subject matter, nor is it intended as an aid in determining the scope of the claimed subject matter.

Embodiments are directed to an anomaly based notification on a calendar. A hosted service, according to embodiments, may initiate operations to provide the anomaly based notification upon detecting an anomaly associated with a calendar event. Next, a change operation associated with the anomaly may be determined based on a context of the calendar event and a type of the anomaly. A notification may be provided for a presentation on the calendar that renders the calendar event. The notification may include an interactive element associated with the change operation.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of providing an anomaly based notification on a calendar, according to embodiments;

FIG. 2 is a display diagram illustrating example components of a hosted service that provides an anomaly based notification on a calendar, according to embodiments;

FIG. 3 is a display diagram illustrating components of a scheme to provide an anomaly based notification on a calendar, according to embodiments;

FIG. 4 is a display diagram illustrating an example of a presentation of an anomaly based notification on a calendar, according to embodiments;

FIG. 5 is a simplified networked environment, where a system according to embodiments may be implemented;

FIG. 6 is a block diagram of an example computing device, which may be used to provide an anomaly based notification on a calendar, according to embodiments; and

FIG. 7 is a logic flow diagram illustrating a process for providing an anomaly based notification on a calendar according to embodiments.

### DETAILED DESCRIPTION

As briefly described above, a hosted service may provide an anomaly based notification on a calendar. In an example scenario, the hosted service may detect an anomaly associated with a calendar event. The calendar event may include an appointment, an in-person meeting, an online conference, and/or a task, among others. The anomaly may designate an unavailability associated with a contextual aspect of the calendar event. The contextual aspect may include a location, a participant, a subject, a time, and/or an event type, among others associated with the calendar event.

Next, a change operation associated with the anomaly is determined based on a context of the calendar event and a type of the anomaly. The type of the anomaly may include a missing aspect, a status change associated with the calendar event, and/or an expected change associated with the calendar event, among others. The context of the calendar event (such as whether the calendar event is an in-person meeting, an online conference, and/or a task, among others) and the type of the anomaly may be analyzed to determine the change operation.

A notification may be provided for a presentation on the calendar that renders, the calendar event. The notification may include an interactive element associated with the change operation. The interactive element may provide an option to reschedule, relocate, and/or replace the contextual aspect of the calendar event.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The Mowing detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing an anomaly based notification on a calendar. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a bard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

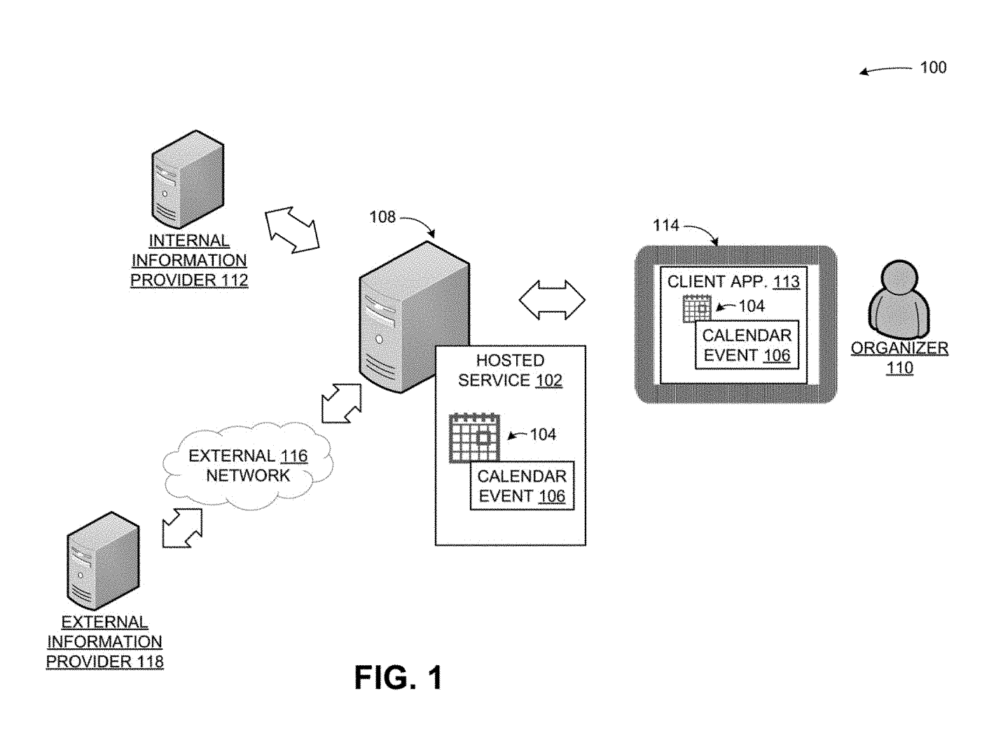

FIG. 1 is a conceptual diagram illustrating examples of providing an anomaly based notification on a calendar, according to embodiments.

In a diagram 100, a server 108 may execute (or provide) a hosted service 102. The server 108 may include a physical server providing service(s), application(s), and/or an interface to client devices. A service (such as the hosted service 102) may include an application performing operations in relation to a client application and/or a subscriber, among others. The server 108 may include and/or is part of a workstation, a data warehouse, a data center, and/or a cloud based distributed computing source, among others.

The server 108 may execute the hosted service 102. The hosted service 102 may detect, an anomaly associated with a calendar event 106. The calendar event 106 may include an appointment, an in-person meeting, an online conference, and/or a task, among others. The calendar event 106 may be hosted in a calendar 104. The anomaly may designate an unavailability associated with a contextual aspect of the calendar event 106. The contextual aspect may include a location, a participant, a subject, a time, and/or an event type, among others associated with the calendar event 106.

The anomaly may be detected in response to receiving a status change associated with the contextual aspect of the calendar event 106. The status change associated with the contextual aspect may be provided from an internal information provider 112 such as a presence provider, and/or a scheduling provider, among others. Furthermore, the status change associated with the contextual aspect may be provided by an external information provider 118 through an external network 116. An example of the external information provider 118 may include a social networking;source, a professional networking source, a product/resource status tracking source, and/or a web based provider, among others.

Next, a change operation associated with the anomaly is determined based on a context of the calendar event 106 and a type of the anomaly. The type of the anomaly may include a missing aspect, a status change associated with the calendar event 106, and/or an expected change associated with the calendar event 106, among others. The context of the calendar event 106 (such as whether the calendar event 106 is an in-person meeting, an online conference, and/or a task, among others) and the type of the anomaly may be analyzed to determine the change operation.

A notification may be provided for a presentation on the calendar 104 that renders the calendar event 106. The notification may include an interactive element associated with the change operation. The interactive element may provide an option to reschedule, relocate, and/or replace the contextual aspect of the calendar event 106.

The server 108 may communicate with a client deice 114, through a network. A client application 113 (executed by the client device 114) may present the calendar 104 and the calendar event 106 to a stakeholder such as an event organizer 110. The network may provide wired or wireless communications between network nodes such as the client device 114 and/or die server 108, among others. Previous example(s) to provide an anomaly based notification on a calendar 104 are not provided in a limiting sense. Alternatively, the hosted service 102 may detect the anomaly associated with the calendar event 106 and provide the notification (with the change operation) as a desktop application, a workstation application, and/or a server application, among others. The client application 113 may also include a client interface interacting with and/or provided by the hosted service 102.

The event organizer 110 may interact with the client application 113 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the server 108, the hosted service 102, embodiments are not limited to these components or system configurations and can be implemented with other system configuration employing fewer or additional components.

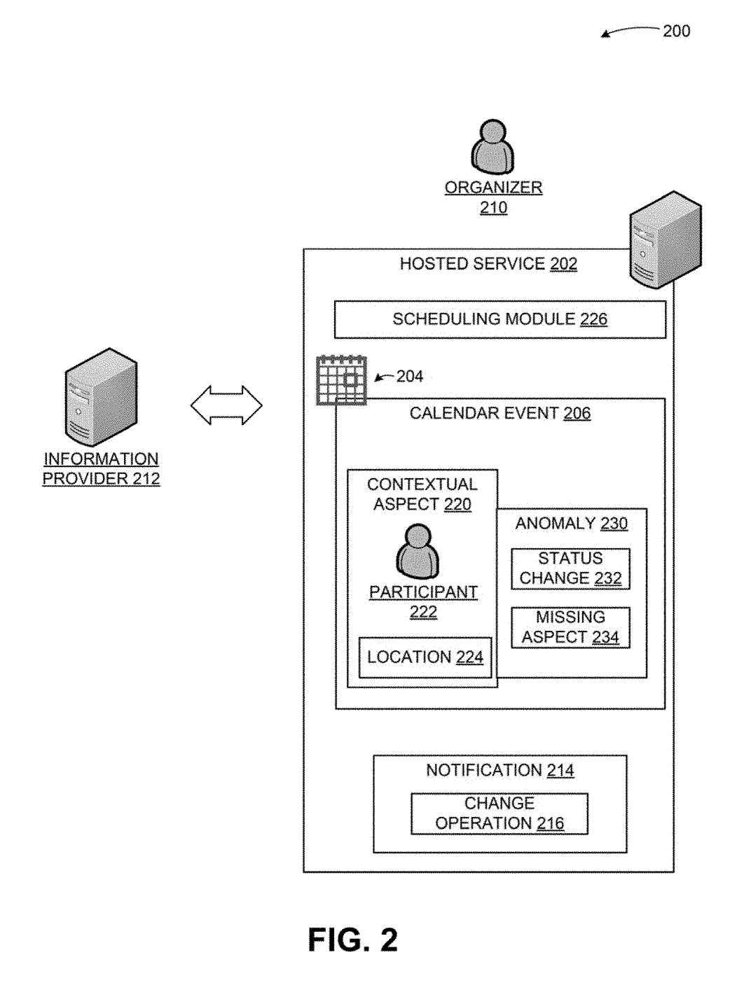

FIG. 2 is a display diagram illustrating example components of a hosted service that provides an anomaly based notification on a calendar, according to embodiments.

As illustrated in diagram 200, a scheduling module 226 of a hosted service 202 may detect an anomaly 230 associated with a calendar event 206. The calendar event 206 may include an appointment, an in-person meeting, an online conference, and/or a task, among others. The calendar event 206 may be hosted and/or rendered on a calendar 204. The calendar 204 may be provided to stakeholder(s) such as an event organizer 210 and/or participant(s) of the calendar event 206.

A type of the anomaly 230 may include a missing aspect 234, a status change 232 associated with the calendar event 206, and/or an expected change associated with the calendar event, among others. The missing aspect 234 may include a lack of a contextual aspect 220 of the calendar event 206. The contextual aspect 220 may include a location 224, a participant 222, a subject, a time, and/or an event type of the calendar event, among others. For example, the calendar event 206 such as an in-person meeting may lack the location 224 (such as a venue, room, and/or building, among others) as the contextual aspect 220.

In another example scenario, the status change 232 associated with the calendar event 206 may create the anomaly 230. For example, the event organizer 210 may change a time of the calendar event 206. The contextual aspect 220 (such as the participant 222) may he unavailable at the new time associated with the status change 232. As such, the status change 212 may create the anomaly 230.

The status change 232 may also be received from an information provider 212 (which may be internal and/or external). The information provider 212 may store, host, and/or track information associated with the contextual aspect 220 of the calendar event 206.

In an additional example scenario, an expected change associated with the calendar event 206 may create the anomaly 230. For example, the scheduling module 226 may detect an insufficient quorum to host the calendar event 206 as a result of an unavailability associated with the contextual aspect 220 (such as an unavailability of the location 224 and/or the participant 222 during the calendar event 206). The scheduling module 226 may infer that the event organizer 210 may replace, reschedule, and/or relocate the contextual aspect 220 to host the calendar event 206. The expected change may be inferred to create the anomaly 230 by causing an unavailability associated with other contextual aspect(s) of the calendar event 206.

Next, the scheduling module 226 may determine a change operation 216 associated with the anomaly 230 based on a context of the calendar event 206 and a type of the anomaly 230. The context of the calendar event 206 (such as whether the calendar event 206 is an in-person meeting, an online conference, and/or a task, among others) and the type of the anomaly may be analyzed to determine the change operation 216. For example, the calendar event 206 may be detected as a meeting and the type of the anomaly 230 may be detected as an unavailability of the participant 222. In response, the scheduling module 226 may determine a rescheduling option as the change operation 216 associated with the anomaly 230.

A notification 214 may also be provided for a presentation on the calendar 204 that renders the calendar event 206. The notification 214 may include an interactive element associated with the change operation 216. The interactive element may provide an option to reschedule, relocate, and/or replace the contextual aspect 220 of the calendar event 206.

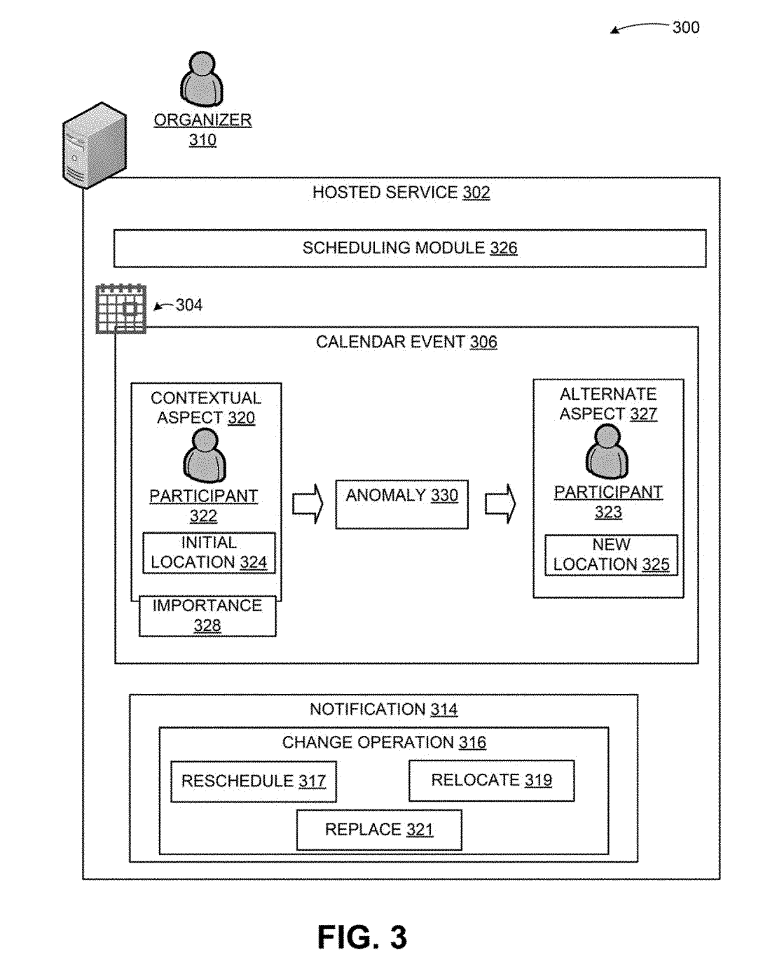

FIG. 3 is a display diagram illustrating components of a scheme to provide an anomaly based notification on a calendar, according to embodiments.

As shown in a diagram 300, a scheduling module 326 of a hosted service 302 may detect an anomaly 330 associated with a calendar event 306 hosted by a calendar 304. The scheduling module 326 may automate mitigation of the anomaly 330 by generating a notification 314 that provides a change operation 316. The change operation 316 may provide an event organizer 310 and/or other stakeholder associated with the calendar event 306 with option(s) to mitigate the anomaly 330. An example may include an option to reschedule 317, relocate 319, and/or replace 321 a contextual aspect 320 of the calendar event 306 associated with the anomaly 330. The contextual aspect 320 may include a location (such as an initial location 324), a participant 322, a subject, a time, and/or an event type of the calendar event 306.

In an example scenario, the scheduling module 326 may detect an unavailability associated with the contextual aspect 320 of the calendar event 306 as the anomaly 330. For example, a status change associated with the participant 322 and/or the initial location 324 may be received. The status change may designate the participant 322 and/or the location 324 as unavailable during the calendar event 306. In response, the scheduling module 326 may create the change operation 316 associated with the anomaly 330. The change operation may maintain the contextual aspect 320 of the calendar event 306.

For example, the scheduling module 326 may evaluate an importance 328 associated with the contextual aspect 320 of the calendar event 306. The importance 328 may be determined as critical to the calendar event 306. In an example scenario, the participant 322 may be a presenter of the calendar event 306 without whom the calendar event 306 may need to be cancelled. Alternatively, the initial location 324 may include a venue which is capable of hosting the calendar event 306. The calendar event 306 may need to be cancelled in a scenario where the initial location 324 is unavailable.

An event organizer 310 of the calendar event 306 may be queried to provide the importance 328 associated with the contextual aspect 320 of the calendar event 306. For example, the event organizer 310 may be asked to provide an importance value to the participant 322 and/or the initial location 324, among other contextual aspect(s) 320 of the calendar event 306. The contextual aspect 320 may be designated with the importance 328 upon receiving the importance 328 from the event organizer 310. Alternatively, the scheduling module 326 may automatically designate the importance 328 associated with the contextual aspect 320 based on one or more attribute(s) associated with the contextual aspect 320 such as a role, and/or a skill associated with the contextual aspect 320.

The scheduling module 326 may include a summary description within the notification 314 to relay the importance 328 associated with the calendar event to the event organizer 310. A critical designation assigned to the importance 328 may be relayed in the notification 314 to prompt the event organizer to execute the change operation 316.

The change operation 316 may include a variety of options to reschedule 317, relocate 319 and/or replace 321 the contextual aspect 320 based on a context of the calendar event 306 and the type of the anomaly 330. In an example scenario, the scheduling module 326 may detect an availability associated with the contextual aspect 320 in an alternate time period. For example, the participant 322 and/or the initial location 324 may be available in the alternative time period. As such, the scheduling module 326 may provide an option to reschedule 317 within the change operation 316 to reschedule the calendar event 306 to the alternate tune period.

In another example scenario, the scheduling nodule 326 may determine an alternate aspect 327 such as a participant 323 and/or a new location 325 to replace the participant 322 and/or the initial location 324 as the contextual aspect 320. The scheduling module 326 may search information provider(s) associated with the alternate aspect(s) 321 to locate the alternate aspect(s) 321 that have equal and/or similar attribute(s) (such as role, and/or skills among others) in relation to the contextual aspect 320. The scheduling module 326 may provide an option to replace 321 the contextual aspect 320 with the alternate aspect 327 upon confirming an availability of the alternate aspect 327 during the calendar event 306.

In an additional example scenario, the scheduling module 326 may detect a lack and/or an unavailability of the initial location 324 associated with the calendar event 306 as the anomaly 330. Next, the scheduling module 326 may provide an option relocate 319 (the calendar event 306) within the change operation 316 to allow the event organizer 310 to select the new location 325 associated with the calendar event. The scheduling module 326 may search a location scheduler for the new location 325. A search property associated with the new location 325 may include proximity to participant(s) of the calendar event 306. The new location 325 may be selected based on nearness to the participant(s). An availability of the new location 325 during the calendar event 306 may also be confirmed. Furthermore, the new location 325 may be determined as capable of hosting the contextual aspect 320 of the calendar event 306 such as the participant 322.

In other example scenario, the scheduling module 326 may detect a reminder associated with the calendar event 306. In response, a location of the participant 322 of the calendar event may be requested from a presence provider associated with the participant 322. The presence provider may include a scheduling information provider associated with the participant 322, and/or a mobile device carried by the participant 322 that tracks the location of the participant 322, among others.

Upon receiving the location of the participant 322, a travel time from the location of the participant 322 to the initial location 324 of the calendar event 306 may be estimated. An unavailability of the participant 322 (during the calendar event 306) may he detected based on an inference that the travel time concludes after a start time of the calendar event 306. A description of the unavailability of the participant 322 (during the calendar event 306) may be included within the notification 314 to alert the event organizer 310.

Next, the new location 325 for the calendar event 306 may be located. The new location 325 may be determined to shorten the travel time of the participant 322 such that the travel time concludes prior to a start time of the calendar event 306. As a result, an option to relocate 319 the calendar event 306 to the new location 325 may be provided within the notification 314.

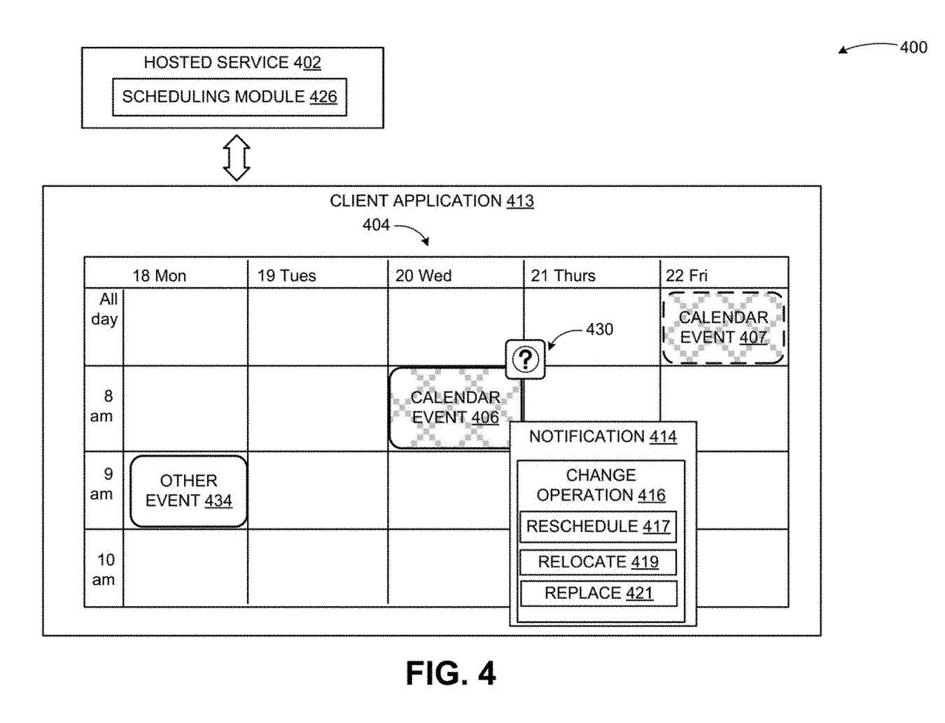

FIG. 4 is a display diagram illustrating an example of a presentation of an anomaly based notification on a calendar, according to embodiments.

As shown in a diagram 400, a scheduling module 426 of a hosted service 402 may provide a notification 414 associated with a calendar event 406 rendered on a calendar 404 (provided by a client application 413). The notification 414 may indicate an anomaly 430 (such as an unavailability of a contextual aspect) associated with the calendar event 406. A stakeholder associated with the calendar event 406 (such as an event organizer of the calendar event 406) may also be informed about the anomaly 430 with other visual cues such as an alert, and/or a warning element, among others. The scheduling module 426 may also provide other event 434 on the calendar for rendering by the client application 413.

The notification 414 may include a change operation 416. The change operation 416 may include an option to reschedule 417, replace 421, and/or relocate 419 a contextual aspect of the calendar event 406. The stakeholder may be allowed to interact with an interactive element within the notification 414 to initiate the change operation 416. Upon detecting an input that activates the change operation 416, the scheduling module 426 may execute the change operation 416 to modify the calendar event 406 based on the provided input (such as rescheduling, replacing, and/or relocating the contextual aspect of the calendar event 406 to mitigate the anomaly 430).

For example, an unavailability of the contextual aspect of the calendar event 406 may be determined. A new time slot for the calendar t 406 may be searched in which the contextual aspect may be determined as available. Upon locating the new time slot (in which the contextual aspect is determined as available), the calendar event 406 may be rescheduled as a calendar event 407 in the new time slot.

In another example scenario, as delivery of the notification 414 may be scheduled based on an importance associated with the anomaly 430. For example, if the importance associated with the anomaly 430 may be detected as critical to the calendar event 406 then the delivery of the notification 414 may be configured for real time delivery upon detection of the anomaly 430. Alternatively, if the importance associated with the anomaly 430 may be detected as insignificant to the calendar event 406 then the delivery of the notification 414 may be configured for on demand delivery in response to a request by an event organizer of the calendar event 406.

As discussed above, the hosted service ma be employed to perform operations to provide an anomaly based notification on a calendar. An increased performance and efficiency improvement with the hosted service 102 may occur as a result of automatically detecting an anomaly associated with a calendar event and determining a change operation associated with the anomaly. Additionally, automated notification generation, transmission, and response implementation operation(s) and process(es) executed by the hosted service 102, and may reduce processor load, increase processing speed, conserve memory, and reduce network bandwidth usage.

Embodiments, as described herein, address a need that arises from a lack of efficiency to provide an anomaly based notification on a calendar. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing an anomaly based notification on a calendar may be implemented in configurations employing fewer or additional components in applications and user interfaces. Furthermore, the example schema and components shown in FIG. 1 through 4 and their subcomponents may be implemented in a similar manner with other values using the principles described herein.

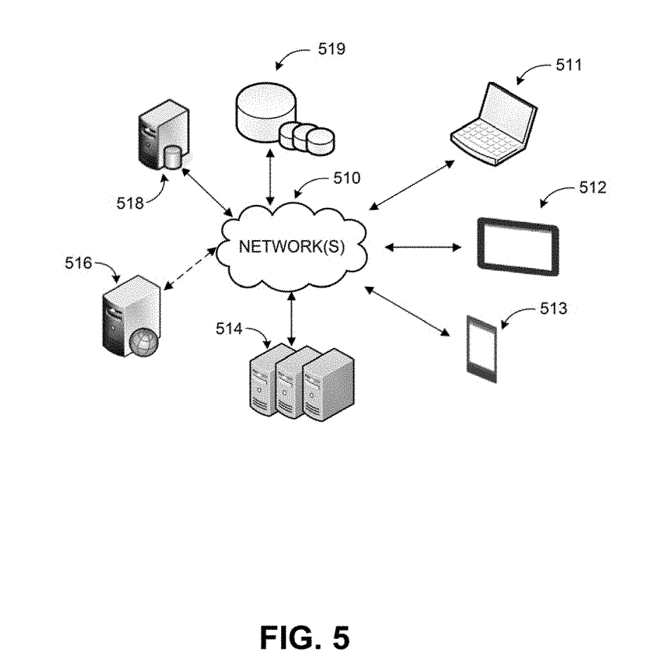

FIG. 5 is an example networked environment, where embodiments may be implemented. A hosted service configured to provide an anomaly based notification on a calendar may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A hosted service may detect an anomaly associated with a calendar event. Next, a change operation associated with the anomaly may be determined based on a context of the calendar event and a type of the anomaly. A notification may be provided for a presentation on the calendar that renders the calendar event. The notification may include an interactive element associated with the change operation. The hosted service may store data associated with the calendar event in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide an anomaly based notification on a calendar. Furthermore, the networked environments discussed in FIG. 5 are for illustration purposes only. Embodiments are not limited to the example applications, modules, or processes.

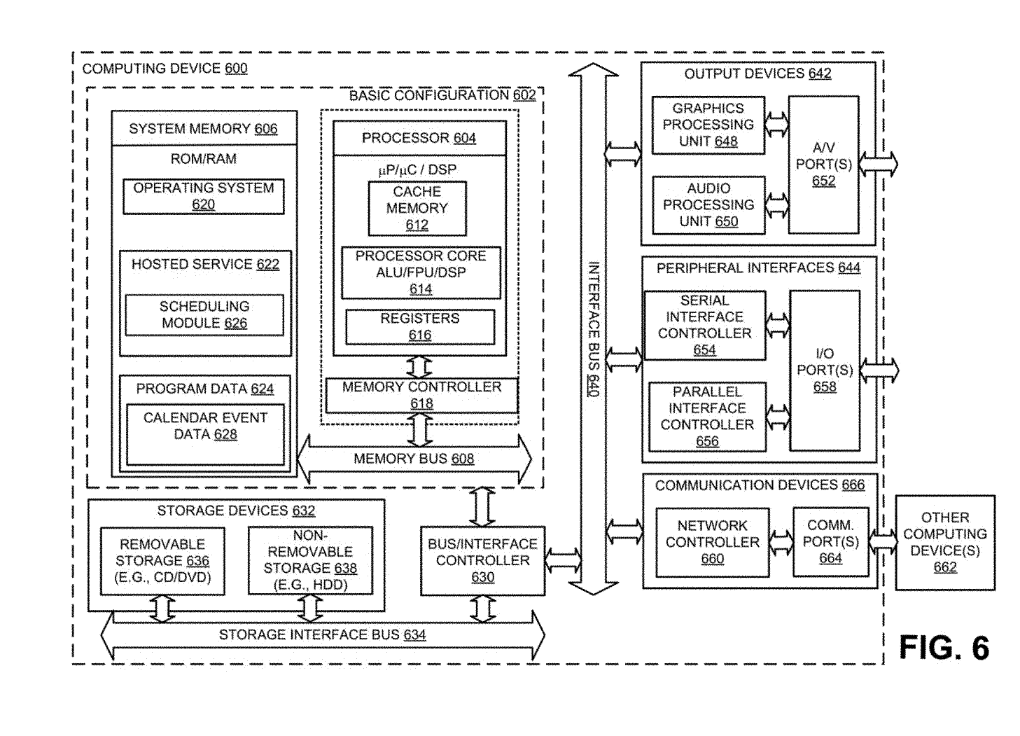

FIG. 6 is a block diagram of an example computing device, which may be used to provide an anomaly based notification on a calendar, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), a graphics processing unit (GPU), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a hosted service 622, and a program data 624. The hosted service 622 may include components such as a scheduling module 626. The scheduling module 626 may execute the processes associated with the hosted service 622. The scheduling module 626 may detect an anomaly associated with a calendar event. Next, a change operation associated with the anomaly may be determined based on a context of the calendar event and a type of the anomaly. A notification may be provided for a presentation on the calendar that renders the calendar event. The notification may include an interactive element associated with the change operation.

Input to and output out of the hosted service 622 may be transmitted through a communication device 666 that may be communicatively coupled to the computing device 600. The communication device 666 may provide wired and/or wireless communication. The program data 624 may also include, among other data, calendar event data 628, or the like, as described herein. The calendar event data 628 may include information associated contextual aspect(s) of the calendar event, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more on-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide an anomaly based notification on a calendar. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

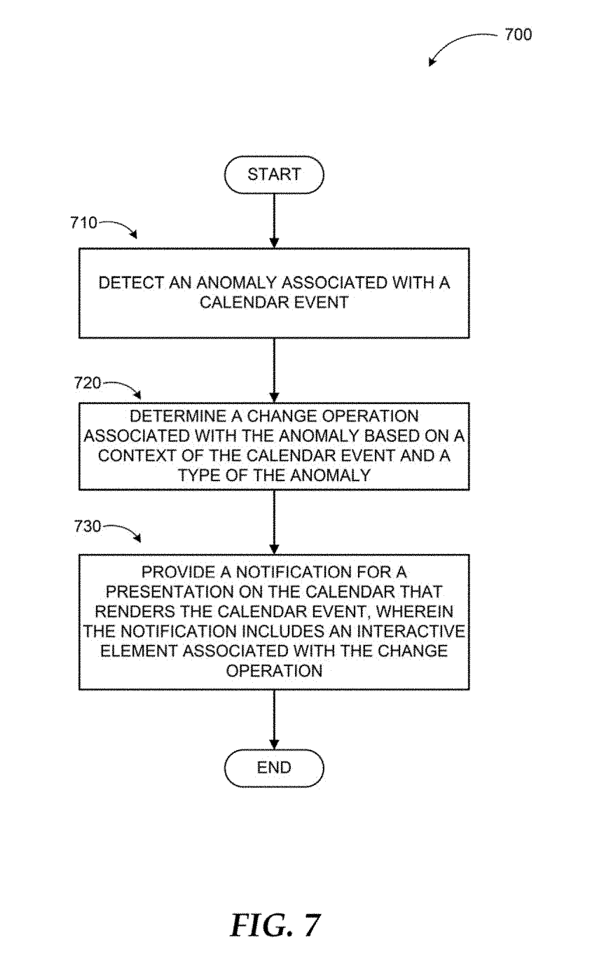

FIG. 7 is a logic flow diagram illustrating a process for providing an anomaly based notification on a calendar, according to embodiments. Process 700 may be implemented on a computing device, such as the computing device 600 or another system.

Process 700 begins with operation 710, where a hosted service may detect an anomaly associated with a calendar event. The anomaly may designate an unavailability associated with a contextual aspect of the calendar event. Next, a change operation associated with the anomaly is determined based on a context of the calendar event and a type of the anomaly at operation 720. The context of the calendar event (such as whether the calendar event is an in-person meeting, an online conference, and/or a task, among others) and the type of the anomaly may be analyzed o determine the change operation.

At operation 730, a notification may be provided for a presentation on the calendar that renders the calendar event. The notification may include an interactive element associated with the change operation. The interact element may provide an option to reschedule, relocate, and/or replace a contextual aspect of the calendar event.

The operations included process 700 is for illustration purposes. Providing an anomaly based notification on a calender may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

According to examples, a means for providing an anomaly based notification on a calendar is described. The means may include a means for detecting an anomaly associated with a calendar event; a means for determining a change operation associated with the anomaly based on a context of the calendar event and a type of the anomaly; and a means for providing a notification for a presentation on the calendar that renders the calendar event, where the notification includes an interactive element associated with the change operation.

According to some examples, a method to provide an anomaly based notification on a calendar is described. The method may include detecting an anomaly associated with a calendar event; determining a change operation associated with the anomaly based on a context of the calendar event and a type of the anomaly; and providing a notification for a presentation, on the calendar that renders the calendar event, where the notification includes an interactive element associated with the change operation.

According to other examples, the type of the anomaly may include one or more of a missing aspect, a status change associated with the calendar event, and an expected change associated with the calendar event. The method may also include detecting an unavailability associated with a contextual aspect of the calendar event as the anomaly; and creating the change operation associated with the anomaly, where the change operation maintains the contextual aspect of the calendar event. The contextual aspect of the calendar event may include one or more of a location, a participant, a subject, a time, and an event type of the calendar event. The method may further include evaluating an importance associated with the contextual aspect of the calendar event; determining the importance associated with the contextual aspect as critical to the calendar event; and including a summary description within the notification, where the summary description emphasizes the importance associated with the contextual aspect designated as critical to the calendar event.

According to further examples, evaluating the importance associated with the contextual aspect of the calendar event may include querying an event organizer of the calendar event to provide the importance associated with the contextual aspect of the calendar event; and receiving the importance associated with the contextual aspect of the calendar event from the event organizer of the calendar event. Creating the change operation associated with the anomaly may include detecting an availability associated with the contextual aspect in an alternate time period; and providing a rescheduling option within the change operation to reschedule the calendar event within the alternate time period. Creating the change operation associated with the anomaly may also include determining an alternate aspect to replace the contextual aspect; confirming an availability of the alternate aspect during the calendar event; and providing a replacement option within the change operation to replace the contextual aspect with the alternate aspect.

According to yet other examples, the method may include detecting one or more of a lack and an unavailability of an initial location associated with the calendar event as the anomaly; and providing a relocation option within the change operation to select a new location associated with the calendar event. Providing the relocation option within the change operation may include searching a location scheduler for the new location in proximity to one or more participants of the calendar event; and confirming an availability of the new location during the calendar event. The new location may be determined as capable of hosting the one or more participants of the calendar event.

According to other examples, a server configured to provide an anomaly based notification on a calendar is described. The server may include a communication device configured to facilitate communication between a hosted service and one or more client devices; a memory configured to store instructions; and a processor coupled to the memory and the communication device, the processor executing the hosted service in conjunction with the instructions stored in the memory, where the hosted service may include a scheduling module configured to detect an anomaly associated with a calendar event; determine a change operation associated with the anomaly based on a context of the calendar event and a type of the anomaly; provide a notification for a presentation on the calendar that renders the calendar event, where the notification includes an interactive element associated with the change operation; receive an input associated with the interactive element, where the input includes one or more selections to modify the calendar event; and modify the calendar event by executing the change operation based on the input.

According to some examples, the scheduling module may be further configured to detect a reminder associated with the calendar event; request a first location of a participant of the calendar event from a presence provider associated with the participant; and receive the first location of the participant from the presence provider. The scheduling module may be further configured to estimate a travel time from the first location of the participant to a second location of the calendar event; detect an unavailability of the participant during the calendar event based on an inference that the travel time concludes after a start time of the calendar event; and include a description of the unavailability of the participant during the calendar event within the notification.

According to other examples, the;scheduling module may be further configured to locate a new location for the calendar event that shortens the travel time of the participant to a conclusion prior to the start time of the calendar event; and provide a relocation option within the change operation to select the new location associated with the calendar event. The scheduling module may also be configured to schedule a delivery of the notification based on an importance associated with the anomaly. The scheduling, module may be further configured to detect the importance associated with the anomaly as critical to the calendar event; and configure the delivery of the notification for real time delivery upon a detection of the anomaly. The scheduling module may be further configured to detect the importance associated with the anomaly as insignificant to the calendar event; and configure the delivery of the notification for on demand delivery in response to a request by an event organizer of the calendar event.

According to further examples, a computer-readable memory device with instructions stored thereon to provide an anomaly based notification on a calendar is described. The instructions may include detecting an anomaly associated with a calendar event; determining a change operation associated with the anomaly based on a context of the calendar event and a type of the anomaly; providing a notification for a presentation on the calendar that renders the calendar event, where the notification includes an interactive element associated with the change operation; receiving an input associated with the interactive element, where the input includes one or more selections to modify the calendar event; and modifying the calendar event by executing the change operation based on the input. The calendar event may include one or more of an appointment, an in-person meeting, an online conference, and a task.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide an anomaly based notification on a calendar, the method comprising:
detecting an anomaly associated with a calendar event;
determining a change operation associated with the anomaly base on a context of the calendar event and a type of the anomaly; and
providing a notification for a presentation on the calendar that renders the calendar event, wherein the notification includes an interactive element associated with the change operation.

2. The method of claim 1, wherein the type of the anomaly includes one or more of a missing aspect, a status change associated with the calendar event, and an expected change associated with the calendar event.

3. The method of claim 1, further comprising:
detecting an unavailability associated with a contextual aspect of the calendar event as the anomaly; and
creating the change operation associated with the anomaly, wherein the change operation maintains the contextual aspect of the calendar event.

4. The method of claim 3, wherein the contextual aspect of the calendar event includes one or more of a location, a participant, a subject, a time, and an event type of the calendar event.

5. The method of claim 3, further comprising:
evaluating an importance associated with the contextual aspect of the calendar event;
determining the importance associated with the contextual aspect as critical to the calendar event; and
including a summary description within the notification, wherein the summary description emphasizes the importance associated with the contextual aspect designated as critical to the calendar event.

6. The method of claim 5, wherein evaluating the importance associated with the contextual aspect of the calendar event comprises:
querying an event organizer of the calendar event to provide the importance associated with the contextual aspect of the calendar event; and
receiving the importance associated with the contextual aspect of the calendar event from the event organizer of the calendar event.

7. The method of claim 3, wherein creating the change operation associated with the anomaly comprises:
detecting an availability associated with the contextual aspect in an alternate time period; and
providing a rescheduling option within the change operation to reschedule the calendar event within the alternate time period.

8. The method of claim 3, wherein creating the change operation associated with the anomaly comprises:
determining an alternate aspect to replace the contextual aspect;
confirming an availability of the alternate aspect during the calendar event; and
providing a replacement option within the change operation to replace the contextual aspect with the alternate aspect.

9. The method of claim 1, further comprising:
detecting one or more of a lack and an unavailability of an initial location associated with the calendar event as the anomaly; and
providing a relocation option within the change operation to select a new, location associated with the calendar event.

10. The method of claim 9, wherein providing the relocation option within the change operation comprises:
searching a location scheduler for the new location in proximity to one or more participants of the calendar event; and
confirming an availability of the new location during the calendar event.

11. The method of claim 10, wherein the new location is determined as capable of hosting the one or more participants of the calendar event.

12. A server configured to provide an anomaly based notification on a calendar, the server comprising:
a communication device configured to facilitate communication between a hosted service and one or more client devices;
a memory configured to store instructions; and
a processor coupled to the memory and the communication device, the processor executing the hosted service in conjunction with the instructions stored in the memory, wherein the hosted service includes:
a scheduling module configured to:
detect an anomaly associated with a calendar event;
determine a change operation associated with the anomaly based on a context of the calendar event and a type of the anomaly;
provide a notification for a presentation on the calendar that renders the calendar event, wherein the notification includes an interactive element associated with the change operation;
receive an input associated with the interactive element, wherein the input includes one or more selections to modify the calendar event; and
modify the calendar event by executing the change operation based on the input.

13. The server of claim 12, wherein the scheduling module is further configured to:
detect a reminder associated with the calendar event;
request a first location of a participant of the calendar event from a presence provider associated with the participant; and
receive the first location of the participant from the presence provider.

14. The server of claim 13, wherein the scheduling module is further configured to:
estimate a travel time from the first location of the participant to a second location of the calendar event;
detect an unavailability of the participant during the calendar event based on an inference that the travel time concludes after a start time of the calendar event; and
include a description of the unavailability of the participant during the calendar event within the notification.

15. The server of claim 14, wherein the scheduling module is further configured to:
locate a new location for the calendar event that shortens the travel time of the participant to a conclusion prior to the start time of the calendar event; and
provide a relocation option within the change operation to select the new location associated with the calendar event.

16. The server of claim 12, wherein the scheduling module is further configured to:
schedule a delivery of the notification based on an importance associated with the anomaly.

17. The server of claim 16, wherein the scheduling module is further configured to:
detect the importance associated with the anomaly as critical to the calendar event; and
configure the delivery of the notification for real time delivery upon a detection of the anomaly.

18. The server of claim 16, wherein the scheduling module is further configured to:
detect the importance associated with the anomaly as insignificant to the calendar event; and
configure the delivery of the notification for on demand delivery in response to a request by an event organizer of the calendar event.

19. A computer-readable memory device with instructions stored thereon to provide an anomaly based notification on a calendar, the instructions comprising:
detecting an anomaly associated with a calendar event;
determining a change operation associated with the anomaly based on a context of the calendar event and a type of the anomaly;
providing a notification for a presentation on the calendar that renders the calendar event, wherein the notification includes an interactive element associated with the change operation;
receiving an input associated with the interactive element, wherein the input includes one or more selections to modify the calendar event; and
modifying the calendar event by executing the change operation based on the input.

20. The computer-readable memory device of claim 19, wherein the calendar event includes one or more of an appointment, an in-person meeting, an online conference, and a task.
